(19) United States
(12) Patent Application Publication
(10) Pub. No.: US 2025/0198571 A1
(43) Pub. Date: Jun. 19, 2025

(54) TWO STAGE CRYOGEN COOLING SYSTEM

(71) Applicant: Supernode Limited, Dublin (IE)

(72) Inventors: Eoin Hodge, Dublin (IE); John McAnerney, Dublin (IE)

(21) Appl. No.: 18/976,490

(22) Filed: Dec. 11, 2024

(30) Foreign Application Priority Data
Dec. 14, 2023 (EP) 23216741.1

(51) Int. Cl. F17C 13/00

(52) U.S. Cl. CPC F17C 13/007; F17C 2223/0161; F17C 2227/0142; F17C 2227/0353; F17C 2270/0527

(57) ABSTRACT

The present invention provides a two stage cryogen cooling system for particular use in cooling a cryogen employed in a superconducting power transmission cable, the cooling system employing a sub-cooler pump such as a venturi pump to effect both cooling stages, the first cooling stage being the cooling of the liquid cryogen flowing through an inner lumen of a cryostat of the cooling system and the second stage being the generation of a supply of gaseous cryogen for supply to a second lumen of the cryostat surrounding the inner lumen.

### CROSS-REFERENCE TO RELATED APPLICATION

This application claims the benefit of European Application Serial No. 23216741.1.

### FIELD

The present invention relates to a two stage cryogen cooling system for use in cooling cryogenic fluids, for example as used during the bulk transport of cryogenic fluids or for cooling superconducting power transmission cables, and in particular a cryogen cooling system which utilises a sub-cooler pump such as a venturi pump to effect a temperature reduction of the cryogenic fluid.

### BACKGROUND

Within superconducting cable systems, at least one electrically conducting element must be maintained at temperatures below the material transition temperature (T_{c}) to enable superconductivity. Superconductor transition temperatures vary from T_{c}<10 K for classic metallic superconductors up to values of T_{c}>100 K for ceramic high-temperature superconductors (HTS).

Superconductors also require stable temperatures during operation to maintain predictable transmission characteristics. As a standard, cryogens such as liquefied gases (Hydrogen, Oxygen, Nitrogen, etc.) are used as cooling mediums to achieve and maintain these temperatures within superconductor systems. It is critical to maintain the HTS core temperature at a sufficiently low value to ensure that a suitable superconducting state is maintained, otherwise the tapes become resistive, develop heat through Joule heating leading to rising temperature and a potential catastrophic runaway situation.

Standard superconductor cable systems use a forced flow, subcooled, single-phase cryogenic fluid such as liquid nitrogen or helium to absorb and evacuate excess thermal energy in order to maintain operational temperatures. The cryogen is circulated within the system to achieve cooling using standard pressurization systems. Excess heat must be removed from the cryogen to maintain a liquefied state for continuous operation and avoid vaporization, which can be achieved through intermittent sub-coolers or cryocoolers. Increased system length necessitates both increased flow rates and system pressures to convey the cryogen which in turn increases the heat load due to the addition of frictional heating. This increases the requirements on heat removal systems and subsequent costs. Over extended distances (>2 km) standard forced flow systems quickly prove uneconomical due to the high costs and low efficiency of the intermittent cooling stations.

Existing forced flow cooling systems require the use of complex and costly equipment and thus involve significant financial outlays, operating costs and maintenance overheads. An alternative to these large scale forced flow cooling systems is the use of evaporative sub-cooling of the cryogenic fluid in order to increase cooling capacity. However sub-cooling requires the use of pumping equipment and/or cryogenic cooling equipment which again increases the complexity of the overall system. This is particularly problematic in subsea, subterranean or other difficult to access environments where maintenance and repair is extremely difficult and potentially dangerous.

The above shortcomings may also be present when transporting liquid cryogen fluids over long distances, where there is again a requirement to maintain the fluid at cryogenic temperatures, which is conventionally achieved using similar forced flow cooling systems. Such cryogen transport pipelines may comprise an inner cryostat for conveying the liquid cryogen, surrounding by one or more layers of insulation.

It is therefore an object of the present invention to provide a cryogen cooling system which incorporates a simplified means of cooling the cryogenic fluid, whether being used to maintain the operating temperature of a superconducting material or simply being transported over long distances for use as a fuel or otherwise. It is a further object of the present invention to provide a cryogen cooling system which is adapted to provide two stage cooling of the cryogenic fluid.

### SUMMARY

According to the invention there is provided a cryogen cooling system comprising a cryostat containing a supply of cryogen in a first lumen of the cryostat; a cooling chamber defining a fluid flow path through which at least a portion of the cryogen is arranged to pass; a sub-cooler pump operable to reduce pressure within the cooling chamber in order to effect cooling of the passing cryogen; wherein the sub-cooler pump has an exhaust line in fluid communication with a second lumen of the cryostat.

Optionally, the sub-cooler pump comprises a venturi pump.

Optionally, the second lumen defines an annular volume at least partially surrounding the first lumen.

Optionally, the second lumen comprises an annular array of longitudinally extending tubes.

Optionally, the fluid flow path extending through the cooling chamber defines a heat exchanger.

Optionally, the fluid flow path through the cooling chamber is in fluid isolation from, and in thermal communication with, the interior of the cooling chamber.

Optionally, the cooling chamber comprises a bath of cooling fluid through which the fluid flow path extends and which is operable to undergo evaporative cooling in response to the reduced pressure established by the sub-cooler pump.

Optionally, the bath of cooling fluid comprises cryogen supplied from the fluid flow path.

Optionally, the venturi pump is driven by a supply of fluid derived from the bath of cooling fluid within the cooling chamber.

Optionally, the cooling system comprises a venturi supply line extending from the cooling chamber to the venturi pump and arranged so that the cooling chamber and part of the venturi supply line provide a pressure head in the venturi supply line sufficient to operate the venturi pump.

Optionally, the cryogen cooling system comprises a second heat exchanger in thermal communication with the venturi exhaust line.

Optionally, the second heat exchanger is located in the cooling chamber.

Optionally, the second heat exchanger is in thermal communication with the bath of cooling fluid within the cooling chamber.

Optionally, the sub-cooler pump is located in the cooling chamber.

Optionally, the fluid flow path through the cooling chamber is in fluid and thermal communication with an interior of the cooling chamber.

Optionally, the fluid flow path through the cooling chamber comprises an evaporator providing fluid communication between the fluid flow path and the cooling chamber and operable to effect evaporation of the cryogen in response to passage through the evaporator.

Optionally, the evaporator comprises an array of nozzles operable to effect evaporation of the cryogen in response to passage through the nozzles.

Optionally, the evaporator comprises a porous material.

Optionally, the fluid flow path comprises a cryostat.

Optionally, the cryostat passes through the cooling chamber.

Optionally, the cryostat is located remotely of the cooling chamber, the fluid flow path comprising a supply line for transferring cryogen from the cryostat to the cooling chamber and a return line for transferring cryogen from the cooling chamber back to the cryostat.

Optionally, the venturi pump is driven by a supply of fluid derived from the cryogen within the cryostat.

Optionally, the cryogen cooling system comprises a venturi supply line extending from the cryostat to the venturi pump.

Optionally, the cryogen cooling system comprises at least one thermoelectric device operable to convert a temperature differential generated by the cryogen in order to provide a local power source.

According to a second aspect of the invention there is provided a superconducting cable system comprising a superconductor and a cryogen cooling system according to the first aspect of the invention, wherein the supply of cryogen is in thermal communication with the superconductor.

As used herein, the term “cable” is intended to cover both subsea and subterranean power cables in addition to above ground or overhead power lines.

As used herein, the term “venturi pump” is intended to mean a negative pressure generating pump which utilises the flow of a fluid, optionally a gas, along a primary flow path which includes a constriction, throat or choke section, from which constriction a secondary flow path extends and in which a negative pressure is established as a result of the flow of fluid through the constriction and which can therefore be used as a vacuum pump.

As used herein, the term “lumen” is intended to mean a space or volume defined within an elongate tubular body or the like and which may extend partially or fully along the length of the body and may be concentrically or eccentrically arranged therein.

### BRIEF DESCRIPTION OF THE DRAWINGS

The present invention will now be described with reference to the accompanying drawings, in which:

FIG. 1 illustrates a schematic cross section of a cryogen forming part of a cryogenic cooling system according to the present invention;

FIG. 2 illustrates a schematic cross section of an alternative form of cryogen forming part of a cryogenic cooling system according to the present invention;

FIG. 3 illustrates a schematic representation of a cryogen cooling system according to an embodiment of the present invention;

FIG. 4 illustrates a schematic representation of a cryogen cooling system according to an alternative embodiment of the present invention;

FIG. 5 illustrates a schematic representation of a source of liquid and gaseous cryogen which may be utilised with the cooling systems of the present invention as illustrated in FIGS. 3 and 4 to facilitate certain transient operating conditions; and

FIG. 6 illustrates a schematic representation of a cryogen cooling system according to a further alternative embodiment of the present invention.

### DETAILED DESCRIPTION

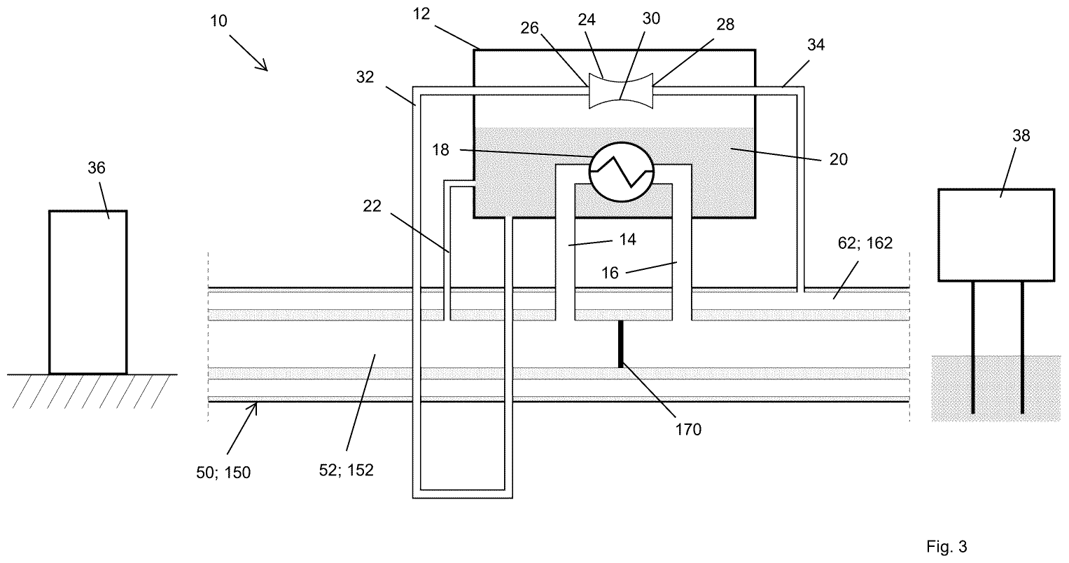

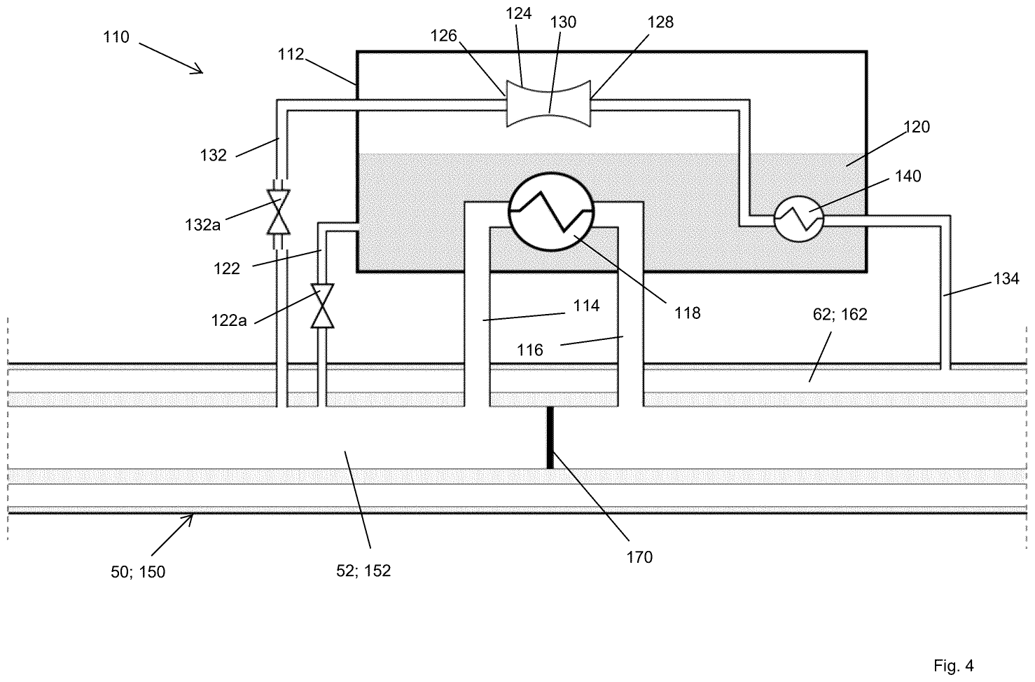

The present invention discloses a cryogen cooling system for cooling a cryogen which has to be transported over relatively long distances, for example in the bulk transport of liquid nitrogen, hydrogen, oxygen, which may be used as fuel or in other applications. The cryogen cooling system of the invention may also be utilised for cooling extended lengths of a high temperature superconductor when used in power cables or lines for electrical transmission. A first embodiment of a cryogen cooling system according to the invention is shown in FIG. 3, generally indicated as 10, while an alternative embodiment of a cooling system according to the invention in shown in FIG. 4, generally indicated as 110. In these alternative embodiments like components have been accorded like reference numerals and unless otherwise stated, perform a like function.

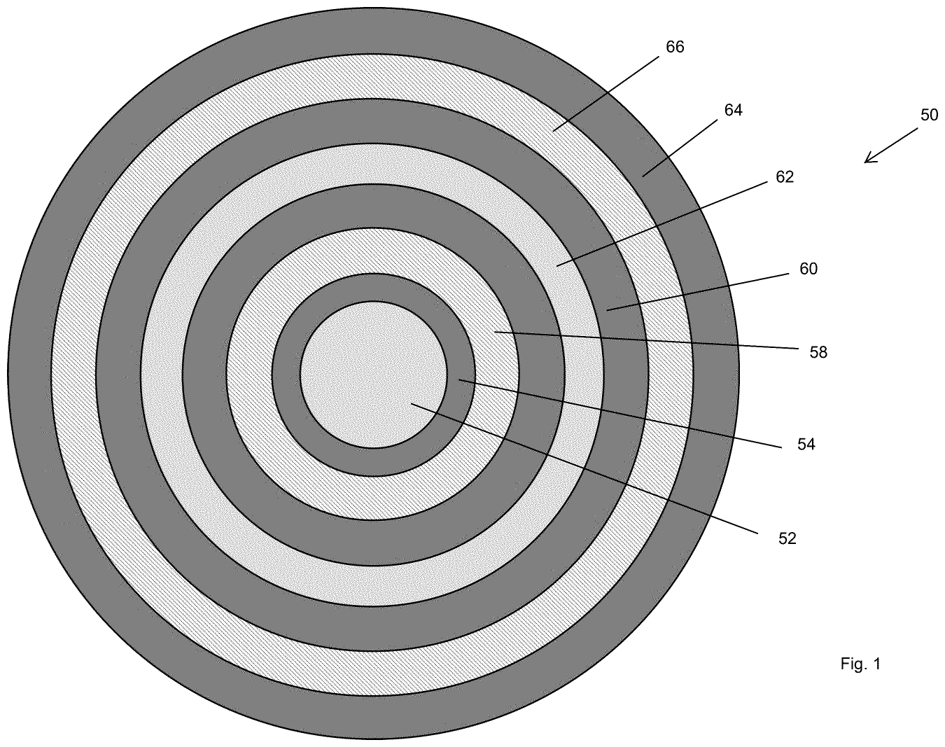

In either application of the above bulk transport and power transmission applications the cryogen cooling system 10; 110 of the invention utilises an elongate cryostat defining at least a part of a fluid flow path for the liquid cryogen. Referring to FIG. 1 of the accompanying drawings there is illustrated a cross section of a first embodiment of such a cryostat, generally indicated as 50, which can thus form part of the cryogen cooling system 10; 110 of the present invention. The cryostat 50 may be part of a superconducting cable including superconducting material cooled by the liquid cryogen conveyed through the cryostat 50 alongside or surrounding the superconducting material. The cryogen is in thermal and optionally physical communication with the superconducting material in order to be capable of maintaining the temperature thereof at the requisite operating temperature, for example between 63 and 77 Kelvin in the case of a high temperature superconducting material. It will of course be understood that this is an exemplary temperature and is not essential to the operation of the present invention.

Alternatively, in liquid cryogen transport applications no such superconducting material is present and the liquid cryogen is simply transported through the cryostat 50 which therefore defines a transport pipeline for the cryogen. The cryostat 50 thus defines an inner lumen 52 within an inner pipe 54 through which the cryogen is transported, preferably in the liquid phase, and in the case of a superconducting cable this inner lumen 52 may also contain the superconductor (not shown), surrounded by and in thermal communication with the liquid cryogen. However as noted above the superconducting material may be located outside the inner lumen 52 or inner pipe 54 once it is in thermal communication with the cryogen contained therein.

The cryostat 50 further comprises a dielectric barrier pipe 56 concentrically arranged radially outward of and spaced from the inner pipe 54 such as to define a thermally insulating vacuum annulus 58 surrounding the inner lumen 52. A further gas containment pipe 60 is arranged radially outward of and spaced from the dielectric barrier pipe 56 such as to define an optionally annular second lumen 62 in which, in use, a gaseous cryogen may be located or circulated in order to provide further thermal insulation for the inner lumen 52, absorbing significant radial heat ingress and thus enabling an extension of the distance that the liquid cryogen contained within the inner lumen 52 can be maintained at the necessary cryogenic temperature without or between being subcooled as detailed hereinafter. Finally, the cryostat 50 comprises an outer pipe 64 arranged radially outward of and spaced from the gas containment pipe 60 such as to define a further thermally insulating vacuum annulus 66. The outer pipe 63 may also comprise a dielectric material as an alternative or addition to the dielectric function of the barrier pipe 56. A person skilled in the art will understand that additional and/or alternative layers or layups or insulation, dielectric and other material may be employed as required to provide particular performance characteristics or to suit particular applications and/or environments.

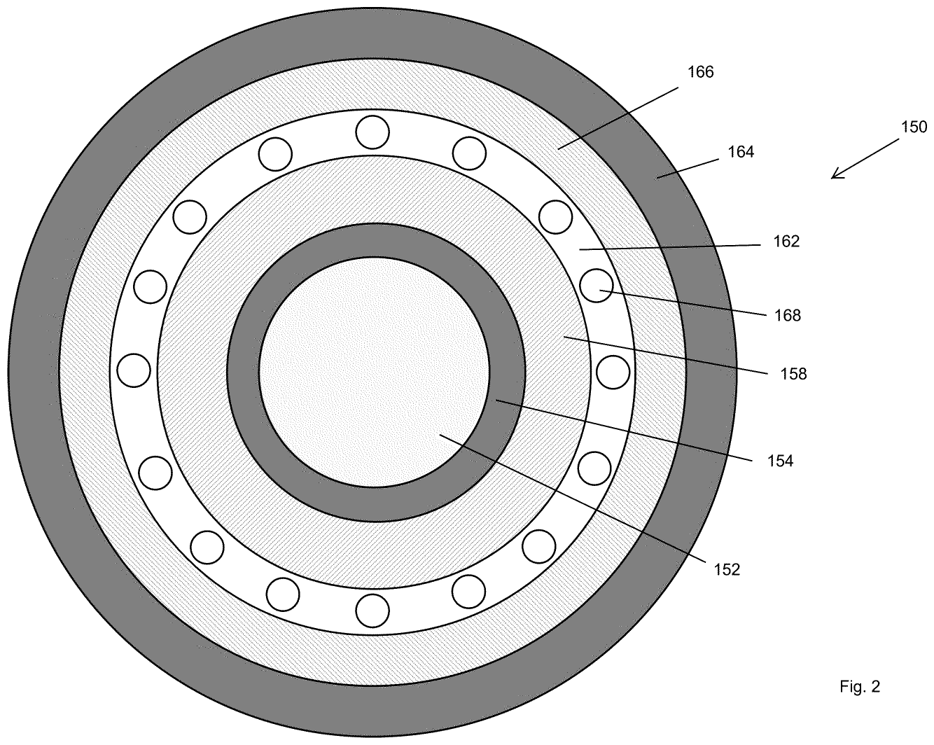

Referring to FIG. 2 there is illustrated a cross section of a second embodiment of a cryostat, generally indicated as 150, which can also form part of the cryogen cooling system 10; 110 of the present invention. The cryostat 150 may be part of a superconducting cable including superconducting material cooled by the liquid cryogen conveyed through the cryostat 150 alongside or surrounding the superconducting material. The cryostat 150 again defines an inner lumen 152 within an inner pipe 154 through which the liquid cryogen is transported, and in the case of a superconducting cable this inner lumen 152 may also contain the superconductor (not shown), surrounded by and in thermal communication with the cryogen. The cryostat 150 further defines an annular second lumen 162 in which, in use, a gaseous cryogen may be located or circulated in order to provide further thermal insulation for the inner lumen 152, absorbing significant radial heat ingress and thus allowing an extension of the distance that the cryogen contained in the inner lumen 152 can be maintained at the necessary cryogenic temperature. Extending longitudinally through the second lumen 162 are a circular array of longitudinally extending fluid tight tubes 168 in which the gaseous cryogen may be contained and pumped along the necessary length of the cryostat 150 in order to provide the necessary thermal sink to assist in maintaining the necessary temperature of the cryogen in the inner lumen 152. The second lumen 162 is radially offset from the inner pipe 152 such as to define a thermally insulting vacuum annulus 158 surrounding the inner pipe 154. Finally, the cryostat 150 comprises an outer pipe 164 arranged radially outward of and spaced from the second lumen 162 such as to define a further thermally insulating vacuum annulus 166. It will again be appreciated that any one or more of the above pipes or layers may comprise a dielectric material.

Referring again to FIG. 3 the first embodiment of the cryogen cooling system 10 is illustrated which as referenced above may form part of a superconducting cable system for use in electrical power transmission. As also detailed above a main component of the cooling system 10 is an extended length of either embodiment of the cryostat 50; 150, which may comprise multiple discrete lengths of the cryostat 50; 150 joined end to end by means an appropriate joint 170. In FIG. 3 the cryostat 50; 150 is shown schematically and not all the features thereof are illustrated.

At one or more locations along the length of the cryostat 50; 150 a cooling chamber 12 in the form of a pressure resistant vessel is provided, externally of the cryostat 50; 150, and through which at least a portion of the liquid cryogen from the inner lumen 52; 152 of the cryostat 50; 150 is diverted in order to cool the cryogen back down to the above mentioned operating temperature before being reintroduced into the cryostat 50; 150. A cryogen supply line 14 extends from the inner lumen 52; 152 into the cooling chamber 12 while a cryogen return line 16 extends from the cooling chamber 12 back to the cryostat 50; 150, effectively forming an extension of the fluid flow path defined by the inner lumen 52; 152 of the cryostat 50; 150. The supply line 14 and return line 16 may be provided as part of or on either side of the joint 170 connecting two lengths of the cryostat 50; 150 or may otherwise be arranged to divert the working cryogen from the inner lumen 52; 152 at appropriate locations along the length of the cryostat 50; 150. For example the supply line 14 may take cryogen at one joint (not shown) while the return line 16 may be feed cryogen back in at another joint on the cryostat 50; 150.

A heat exchanger in the form of a cooling element 18 extends through the interior of the cooling chamber 12 between the supply line 14 and the return line 16 to form a portion of the cryogen fluid flow path. In this embodiment the cooling element 18 is a simple fluid tight tube which is optionally undulating or coiled in order to increase the length of the fluid flow path defined by the cooling element 18. In this way the cryogen flow path from the supply line 14, through the cooling element 18 and through the return line 16 is in fluid isolation from the interior of the cooling chamber 12, but is in thermal communication therewith, for example by means of the material selected for at least the cooling element 18, namely a thermally conductive material. As a result heat transfer between the cryogen in the cooling element 18 and the interior of the cooling chamber 12 can occur while preventing fluid flow from the cooling element 18 into the interior space of the cooling chamber 12. The interior of the cooling chamber 12 is at least partially filled with a cooling fluid 20, optionally the same cryogen flowing through the cryostat 50; 150, such that the cooling element 18 is at least partially and optionally completely immersed in the cooling fluid 20. The cooling element 18 of the fluid flow path thus effectively defines a heat exchanger operable to transfer heat from the cryogen flowing through the fluid flow path defined by the cooling element 18 into the cooling fluid 20. A fill line 22 may be provided from the supply line 14 to the cooling chamber 12 in order to fill and maintain the level of cooling fluid 20 in the cooling chamber 12. Suitable flow controls (not shown) such as valves or the like may be provided on the fill line 22 in order to manage the flow rate of cooling fluid into the cooling chamber 12.

The cryostat 50; 150 is continuous between the supply line 14 and return line 16, particularly in the case of superconducting cable applications, with electrically conducting and preferably superconducting material (not shown) extending across the joint 170. In the case of a cryogen transport application this continuity is not a requirement and could be omitted given that the liquid cryogen can flow uninterrupted along the flow path defined by the supply line 14, cooling element 18 and return line 16. As a result the joint 170 could form a fluid barrier within the inner lumen 52; 152.

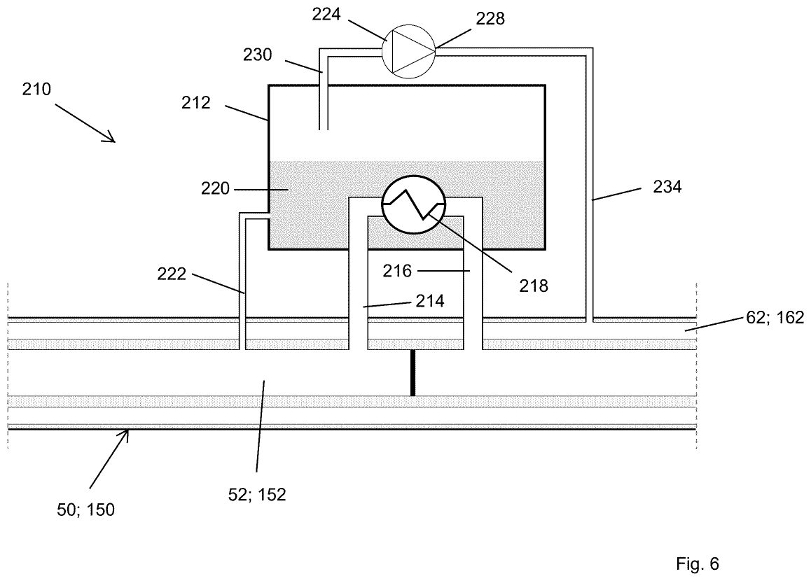

The cooling system 10 further comprises a venturi pump 24 having an inlet 26 and outlet 28 across which a fluid, preferably the same liquid cryogen as flows through the inner lumen 52; 152 and/or is contained in the cooling chamber 12, may be driven in order to create a reduced pressure region at a throat 30 of the venturi pump 24. The venturi pump 24 is located within a headspace of the cooling chamber 12 such that the reduced pressure region at the throat 30 effects a reduction of pressure within the headspace of the cooling chamber 12. It will also be understood that the venturi pump 24 could be located outside of the cooling chamber 12 with the throat 30 being arranged in fluid communication with the headspace of the cooling chamber 12 in order to achieve the same functionality. It will also be appreciated that while preferred, the venturi pump 24 could be replaced with an alternative sub-cooler pump (not shown) such as a more conventional mechanically operated vacuum pump (not shown) as detailed in relation to an embodiment of the invention shown in FIG. 6. However the use of the venturi pump 24 provides a number of operational advantages which render it the preferred form of sub-cooler pump. The reduced pressure generated by the venturi pump 24 within the cooling chamber 12, for example 200 mbar, effects evaporative cooling of the bath of cooling fluid 20. The pressure established in the cooling chamber 12 may be carefully controlled, for example by the design and operation of the venturi pump 24, to ensure that the temperature of the cooling fluid 20 is maintained at the correct level to achieve the desired cooling of the cryogen flowing through the cooling element 18. As a portion of the cooling fluid 20 will evaporate under the lowered pressure generated by the venturi pump 24 the fill line 22 can be operated to maintain a set level of cooling fluid 20 within the cooling chamber 12. In an exemplary embodiment the fill line 22 is operated to extract approximately 10% of the cryogen from the cryostat 50; 150 in order to replace the evaporated cooling fluid 20.

A venturi supply line 32 extends from a base of the cooling chamber 12 to the inlet 26 of the venturi pump 24 such that the cooling fluid 20 may be used as the source of driving fluid for the venturi pump 24. The venturi supply line 32 extends below the cooling chamber 12 before extending upwardly to the venturi pump 24. The distance the venturi supply line 32 extends below the cooling chamber 12 is selected to establish a hydraulic pressure head in the venturi supply line 32 which can then support the pressurised evaporation of the cooling fluid 20, for example liquid nitrogen, in the upwardly extending portion of the venturi supply line 32 to create a pressurised flow of gaseous nitrogen (or other cryogen) to be driven through the venturi pump 24. The pressure head can also act to prevent backflow of the cooling fluid 20 in the venturi supply line 32. A check valve (not shown) and/or expansion valve (not shown) may be provided in the venturi supply line 32, for example along the lowermost section thereof, to facilitate the phase change from liquid to gaseous cryogen. Optionally, the thermal design of the venturi supply line 32 may be such as to effect controlled evaporation and pressurisation of the gaseous cryogen in order to drive the venturi pump 24. Further optionally heating elements (not shown) may be employed to effect vaporisation of the liquid cryogen in the venturi supply line 32. This flow of gaseous cryogen is then the driving fluid of the venturi pump 24 which can be utilised to reduce the pressure in the cooling chamber 12 by means suction generated at the throat 30 of the venturi pump 24 and thus within the headspace of the cooling chamber 12.

It will therefore be appreciated that the temperature of the cryogen returned to the cryostat 50; 150 through the return line 16 can be maintained at the necessary level by means of the cooling chamber 12 and venturi pump 24 which do not include any moving parts, thus greatly improving the reliability of the cryogen cooling process. As a means of further improving efficiency, the cryogen cooling system 10 employs a second cooling stage, utilising gaseous exhaust cryogen from the venturi pump 24 to supply and maintain a thermal sink envelope of gaseous cryogen in the second lumen 62; 162. The cryogen cooling system 10 thus comprises a venturi exhaust line 34 extending from the outlet 28 of the venturi pump 24 to the second lumen 62; 162 of the cryostat 50; 150 in order to facilitate the channeling of the gaseous cryogen, for example gaseous nitrogen, exiting the outlet 28 following expansion through the venturi pump 24, combined with the gaseous cryogen drawn out of the cooling chamber 12 via the throat 30. The venturi pump 24 is configured to generate sufficient pressure in the exhausted gaseous cryogen to drive the cryogen along the necessary length of the cryostat 50; 150, although it is also envisaged that additional downstream pressure management may be employed if required.

In the embodiment illustrated the venturi exhaust line 34 passes out of the cooling chamber 12 before extending downwardly into the cryostat 50; 150, opening into the second lumen 62; 162. In the case of the cryostat 50 the gaseous cryogen will flow directly into the second lumen 62 to surround the inner lumen 52 along a predetermined length of the cryostat. This envelope of gaseous cryogen thus provides sensible cooling along the respective length of the cryostat 50. The gaseous cryogen can also absorb significant radial heat ingress and serves to maintain a reduced temperature of the liquid cryogen (and superconductor) within the inner lumen 52, extending the distance necessary between adjacent cooling chambers 12 along the extended length of the superconducting cable. In the case of the cryostat 150 the gaseous cryogen is fed into the circular array of longitudinally extending tubes 168 which provide the same thermal management functionality. A suitable manifold (not shown) may be arranged to distribute the gaseous cryogen into the tubes 168. The gaseous cryogen may then be vented to the surroundings or may be captured for reuse. For example in a submarine cabling application the liquid cryogen supplying the inner lumen 52, 152 may be supplied from an onshore cryogen supply station 36 while the vented gaseous cryogen from the second lumen 62; 162 may be captured for reuse at an offshore collection station 38.

Referring now to FIG. 4 the second embodiment of the cryogen cooling system 110 is illustrated, and which is again suitable for use in electrical power transmission or bulk cryogen transport. In this second embodiment like components have been accorded like reference numerals and unless otherwise stated perform a like function. The cooling system 110 comprises the cryostat 50; 150 defining a fluid flow path for a liquid cryogen within the inner lumen 52; 152, a cooling chamber 112 into which extends a supply line 114 and out of which runs a return line 116, with a first heat exchanger in the form of a cooling element 118 connected therebetween within the interior space of the cooling chamber 112. The cooling element 118 is in the form of a coiled or corrugated tube of thermally conductive material, the cooling chamber 112 being filled with a cooling fluid 120 to immerse the cooling element 118. A fill line 122 is provided between the inner lumen 52; 152 and the cooling chamber 112 in order to allow the level of the cooling fluid 120 to be maintained despite evaporation during use, with the cryogen being replenished directly from the liquid cryogen flowing though the inner lumen 52; 152. A flow control valve 122a is provided on the fill line 122 to manage the supply of cryogen to the cooling chamber 112.

The cryogen cooling system 110 further comprises a venturi pump 124 having an inlet 126 and outlet 128 across which a fluid, preferably the same liquid cryogen as flows through the inner lumen 52; 152 may be driven in order to create a reduced pressure region at a throat 130 of the venturi pump 124. The venturi pump 124 is located within a headspace of the cooling chamber 112 such that the reduced pressure region at the throat 130 effects a reduction of pressure within the headspace of the cooling chamber 112 as hereinbefore described. Again it will be understood that the venturi pump 124 could be located outside of the cooling chamber 112. The inlet 126 is connected via a venturi supply line 132 to the inner lumen 52; 152 such that the liquid cryogen from the cryostat 50; 150 is used directly as the source of driving fluid for the venturi pump 124. The liquid cryogen is then allowed to evaporate to create a pressurised flow of gaseous nitrogen (or other cryogen) to be driven through the venturi pump 124. An expansion valve 126a is provided in the venturi supply line 132 to facilitate this phase change from liquid to gaseous cryogen. This flow of gaseous cryogen is then the driving fluid of the venturi pump 124. The venturi pump 124 further comprises an outlet 128 extending from which is a venturi exhaust line 134 and which is connected at the opposed end into the second lumen 62; 162 of the cryostat 50; 150 to provide a second stage of cooling as hereinbefore described with reference to the previous embodiment. The venturi exhaust line 134 in this embodiment passes through a second heat exchanger 140 which is located within the cooling chamber 112, and preferably submerged within the liquid phase of the cryogen 120 contained therein. In this was the heat exchanger 140 can lower the temperature of the gaseous cryogen prior to being introduced into the second lumen 62; 162 in order to increase the cooling efficiency of this second cooling stage. It will be appreciated that such a heat exchanger could be utilised with the cooling system 10 of the previous embodiment.

In either of the above described embodiments the cooling element 18; 118 may be arranged to facilitate fluid transfer in the form of evaporation of a portion of the cryogen flowing from the inner lumen 52; 152 through the interior volume of the cooling chamber 12; 112 in order to effect cooling of the remaining liquid cryogen in the catheter 50; 150 via the latent heat of vaporisation. Unlike the previously described embodiments the interior volume of the cooling chamber 12; 112 would not filled with a cooling fluid in order to allow this evaporation to take place. The cooling element 18; 118 would then be provided in the form of a tube of porous or wick like material forming an outer wall of the cooling element and across which a portion of the liquid cryogen will migrate. Due to the low pressure environment within the cooling chamber 12; 112, the liquid cryogen will evaporate into the interior volume of the cooling chamber 12; 112. This evaporation will effect cooling of the remaining liquid cryogen passing through the cooling element 18; 118 which then flows out of the cooling chamber 12; 112 and back into the inner lumen 52; 152 to continue cooling the superconducting material. Such porous or wick lick material is disclosed in the Applicant's International patent application PCT/EP2022/085848.

Alternatively, the cooling element 18; 118 may be arranged to facilitate fluid transfer in the form of evaporation of a portion of the liquid cryogen flowing through the cooling element 18; 118 by incorporating a plurality of nozzles (not shown) which may be provided on or formed integrally with the cooling element 18; 118 when in tubular form as described above. The nozzles (not shown) are configured to effect evaporation of the cryogen in response to passage through the nozzles in combination with a low pressure environment within the cooling chamber 12; 112. This evaporation of a portion of the cryogen through the nozzles will effect cooling of the remaining liquid cryogen which then flows out of the cooling chamber 12; 112 and back into the inner lumen 52; 152 to continue cooling the superconducting material. Examples of such nozzles and a detailed explanation of the configuration and operation of exemplary configurations are disclose in the Applicant's International patent application PCT/EP2023/061767.

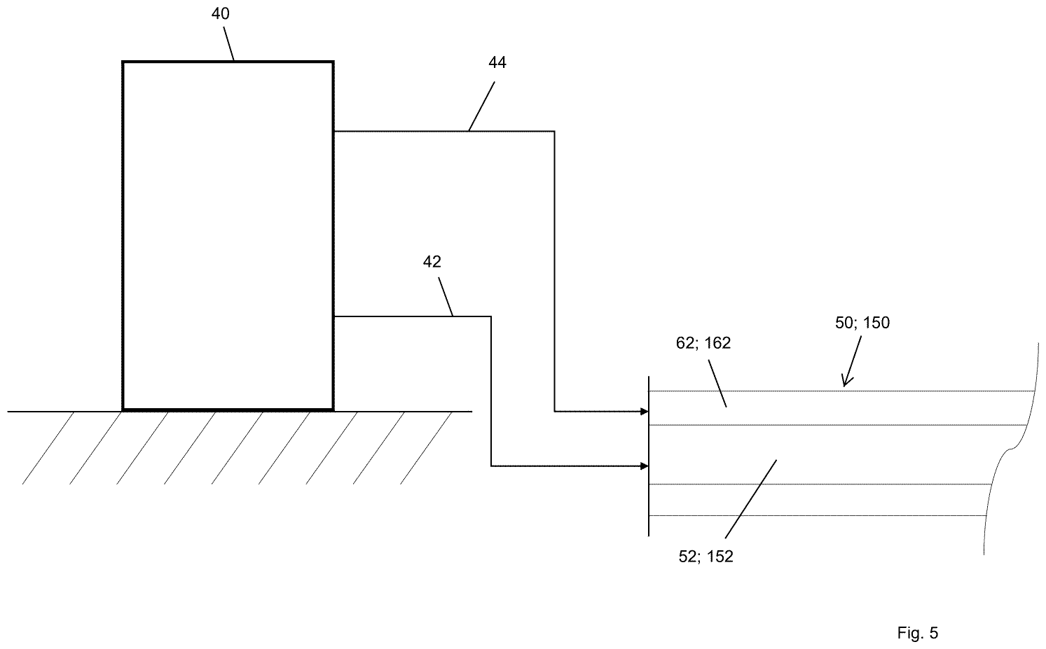

The cooling system 10; 110 of the present invention may comprise, as illustrated schematically in FIG. 5, a supply of liquid and/or gaseous cryogen 40 which may be in the form of a discrete reservoir or a continuous supply, and may for example be located in close proximity to one or both ends of the cryostat 50; 150. Intermediate cryogen supplies 40 may also be provided at various positions along the length of the cryostat 50; 150 if required, for example in the case of very long distance power transmission applications or the like. The cryogen supply 40 is preferably arranged to be capable of providing a supply of liquid cryogen to the inner lumen 52; 152, whether continuously or intermittently, and for example to maintain the correct operational levels of liquid cryogen therein, which will be consumed over time by the cooling chamber 12; 112; and/or the venturi pump 34; 134. A liquid feed line 42 thus extends from the cryogen supply 40 to the inner lumen 52; 152.

In a similar arrangement the cryogen supply 40 is preferably additionally or alternatively arranged to be capable of providing a supply of gaseous cryogen to the outer lumen 62; 162 in order to again establish and/or maintain the correct operational levels of cryogen therein. For example when the cooling system 10; 110 is initial actuated the outer lumen 62; 162 will not contain any gaseous cryogen, so the cryogen supply 40 may be used to initially fill the outer lumen 62; 162 until the venturi pump 34; 134 is fully operational and supplying the necessary volume of gaseous cryogen from the exhaust thereof. A gaseous feed line 44 extends from an upper portion of the cryogen supply 40 to one or more entry points in the second lumen 62; 162.

Referring now to FIG. 6 a further embodiment of a cryogen cooling system according to the invention is illustrated, generally indicated as 210, and which is again suitable for use in electrical power transmission or bulk cryogen transport. In this further embodiment like components have been accorded like reference numerals and unless otherwise stated perform a like function. As with the previous embodiments the cooling system 210 comprises the cryostat 50; 150 defining a fluid flow path for a liquid cryogen within the inner lumen 52; 152, a cooling chamber 212 into which extends a supply line 214 and out of which runs a return line 216, with a first heat exchanger in the form of a cooling element 218 connected therebetween within the interior space of the cooling chamber 212. The cooling element 218 may be in the form of a coiled or corrugated tube of thermally conductive material, the cooling chamber 212 being filled with a cooling fluid 220 to immerse the cooling element 218. A fill line 222 is provided between the inner lumen 52; 152 and the cooling chamber 212 in order to allow the level of the cooling fluid 220 to be maintained despite evaporation during use, with the cryogen being replenished directly from the liquid cryogen flowing though the inner lumen 52; 152.

The cryogen cooling system 210 further comprises a sub-cooler pump 224 located outside the cooling chamber 212 and which may for example be a conventional electrically powered and mechanically driven vacuum pump. The sub-cooler pump 224 is in fluid communication with a headspace of the cooling chamber 212 by means of an intake 230 in order to generate reduced pressure within the headspace as hereinbefore described. It will be understood that the sub-cooler pump 224 could be located within the cooling chamber 212. The sub-cooler pump 224 is thus operable to generate a pressurised flow of gaseous nitrogen (or other cryogen) drawn from the cooling chamber 212 which is driven through the sub-cooler pump 224 and exhausted at an outlet 228. Extending from the outlet 228 is an exhaust line 234 which is connected at the opposed end into the second lumen 62; 162 of the cryostat 50; 150 to provide a second stage of cooling as hereinbefore described with reference to the previous embodiments. The exhaust line 234 may, as in the previous embodiment, be passed through a second heat exchanger (not shown) located within the cooling chamber 212, and preferably submerged within the liquid phase of the cryogen 220 contained therein. In this way the heat exchanger can lower the temperature of the gaseous cryogen prior to being introduced into the second lumen 62; 162 in order to increase the cooling efficiency of this second cooling stage.

It is further envisaged that in any embodiment of the invention one or more thermoelectric devices (not shown) such as a peltier cell may be employed to generate local electrical power based on a temperature differential which may be established using the reduced temperatures of the cryogenic fluids employed. This locally generated power may be used to operate one or more components of the cooling system 10; 110.

It will therefore be understood that the cryogen cooling systems 10; 110 of the invention allow for localised cooling of the cryogen flowing through the cryostat 50; 150, and by means of a venturi pump 24; 124. In addition the single venturi pump effects both cooling stages, the cooling of the liquid cryogen flowing through the inner lumen 52; 152 and the generation and/or cooling of the gaseous cryogen flowing through the second lumen 62; 162. In this way conventional vacuum pumps can be avoided, which employ high speed drive shafts/rotors, seals, and other moving parts that can wear and thus reduce performance. In the case of superconducting cables, any reduction in performance of such a crucial component, which would lead to a reduction in the cooling performance and therefore an unacceptable increase in the temperature of the superconducting material, can lead to catastrophic failure.

The invention is not limited to the embodiments described herein but can be amended or modified without departing from the scope of the present invention.

What is claimed is:

1. A cryogen cooling system comprising a cryostat containing a supply of cryogen in a first lumen of the cryostat; a cooling chamber defining a fluid flow path through which at least a portion of the cryogen is arranged to pass; a sub-cooler pump operable to reduce pressure within the cooling chamber in order to effect cooling of the passing cryogen; wherein the sub-cooler pump has an exhaust line in fluid communication with a second lumen of the cryostat.

2. A cryogen cooling system according to claim 1 in which the sub-cooler pump comprises a venturi pump.

3. A cryogen cooling system according to claim 1 in which the second lumen defines an annular volume at least partially surrounding the first lumen.

4. A cryogen cooling system according to claim 1 in which the second lumen comprises an annular array of longitudinally extending tubes.

5. A cryogen cooling system according to claim 1 in which the fluid flow path extending through the cooling chamber defines a first heat exchanger.

6. A cryogen cooling system according to claim 1 in which the fluid flow path through the cooling chamber is in fluid isolation from, and in thermal communication with, the interior of the cooling chamber.

7. A cryogen cooling system according to claim 1 in which the cooling chamber comprises a bath of cooling fluid through which the fluid flow path extends and which is operable to undergo evaporative cooling in response to the reduced pressure established by the sub-cooler pump.

8. A cryogen cooling system according to claim 7 in which the sub-cooler pump comprises a venturi pump driven by a supply of fluid derived from the bath of cooling fluid within the cooling chamber.

9. A cryogen cooling system according to claim 8 comprising a venturi supply line extending from the cooling chamber to the venturi pump and arranged so that the cooling chamber and part of the venturi supply line provide a pressure head in the venturi supply line sufficient to operate the venturi pump.

10. A cryogen cooling system according to claim 1 in which the cryogen cooling system comprises a second heat exchanger in thermal communication with the venturi exhaust line.

11. A cryogen cooling system according to claim 10 in which the second heat exchanger is located in the cooling chamber.

12. A cryogen cooling system according to claim 1 in which the sub-cooler pump is located in the cooling chamber.

13. A cryogen cooling system according to claim 1 in which the fluid flow path through the cooling chamber is in fluid and thermal communication with an interior of the cooling chamber.

14. A cryogen cooling system according to claim 1 in which the fluid flow path through the cooling chamber comprises an evaporator providing fluid communication between the fluid flow path and the cooling chamber and operable to effect evaporation of the cryogen in response to passage through the evaporator.

15. A cryogen cooling system according to claim 1 in which the cryostat is located remotely of the cooling chamber, the fluid flow path comprising a supply line for transferring cryogen from the cryostat to the cooling chamber and a return line for transferring cryogen from the cooling chamber back to the cryostat.

16. A cryogen cooling system according to claim 1 in which the venturi pump is driven by a supply of fluid derived from the cryogen within the cryostat.

17. A cryogen cooling system according to claim 1 comprising a venturi supply line extending from the cryostat to the venturi pump.

18. A cryogen cooling system according to claim 1 comprising at least one thermoelectric device operable to convert a temperature differential generated by the cryogen in order to provide a local power source.

19. A superconducting cable system comprising a superconductor and a cryogen cooling system according to claim 1, wherein the supply of cryogen is in thermal communication with the superconductor.
